(19) United States
(12) Patent Application Publication
(10) Pub. No.: US 2002/0165951 A1
(43) Pub. Date: Nov. 7, 2002

(54) Method and device for offering resources in an internet appliance

(76) Inventor: Mark Robert Watkins, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/129,657

(22) PCT Filed: Oct. 9, 2001
(86) PCT No.: PCT/GB01/04469

(30) Foreign Application Priority Data
Oct. 10, 2000 (EP) 00308910.9

(51) Int. Cl. G06F 15/173

(52) U.S. Cl. 709/223

(57) ABSTRACT

An e-appliance 110 detects that certain resources are lacked and offers to augment them by utilising the resources of an external service provider 120. The resources experiencing the deficiency may be either functional resources 116 within the e-appliance or may be resources involved in the pursuits of the user in which the e-appliance is being exploited.

The invention relates to an e-appliance and the augmentation of the capabilities of an e-appliance. An e-appliance is defined broadly as a unit for performing data processing and is adapted for communication with remote services. An e-appliance may be a sealed unit or have otherwise unmodifiable hardware and or software.

An example of an e-appliance is a server in a client-server system. Presently, servers are not usually off-the-shelf units, due to the variation in the capabilities required by the users of servers. A server is normally assembled from selected processing and storage resources, which have been selected with regard to the forecasted demands on the server. A database can also be implemented as an e-appliance, and will similarly be a bespoke unit, assembled from components selected by the system manager or designer having regard to the demands on the database. Clearly, it is time-consuming and expensive to create bespoke e-appliances in this way. Furthermore, when the demands on such an e-appliance increase, the e-appliance needs to be rebuilt to meet the new requirements.

It is an object of the present invention to ameliorate the problems associated with creating, maintaining and updating e-appliances.

According to one aspect, the invention provides an e-appliance, comprising: resources for performing data processing functions required of the e-appliance; and a detector for monitoring the condition of the e-appliance and arranged to trigger the offer of an external service to a user of the e-appliance when detecting a predetermined condition indicative of user need.

According to another aspect, the invention provides a method of augmenting the capabilities of an e-appliance, comprising: arranging that the e-appliance monitors its own condition and triggers the offer of an external service to a user of the e-appliance when detecting a predetermined condition indicative of user need.

Preferably, the user's response to said offer is communicated by the e-appliance to remote services for appropriate action. These services may be provided by an internet service provider ISP, who may be the sole ISP for the user, or may be an ISP selected from a number of possible ISPs, for example, via a brokering service.

The invention therefore provides for the servicing of a user need in a timely and efficient manner.

It will be appreciated that the user need may be a real need or a perceived need depending upon the predetermined condition set up to indicate said need.

In one embodiment, the user need comprises a lack of resources associated with the e-appliance.

The lack of resources may be caused by a failure of resources associated with the e-appliance or by use of the e-appliance exceeding its resources. The lacked resources may be the ability to store data or the ability to process data; for example, the ability to handle e-mail or the ability to back-up data. The lacked resources may be hardware resources, or resources used to support the running of application programmes (in which case the resources would also include, for example, operating system software in addition to hardware).

In another embodiment, the user need may comprise a solution to an undesirable situation for the user, such as the occurrence of a non-optimal financial situation, or high telecommunications charges, or a lack of human resources.

In another embodiment, the user need may comprise the need for services complementary to those already provided.

The predetermined condition detected by the e-appliance may be modifiable, or alternatively or additionally, there may be a group of predetermined conditions, each of which may trigger an offer of a respective service.

In one embodiment, it is arranged that the offer of the service is provided a period prior to the condition occurring. The period may be determined so as to enhance the attractiveness of the offer to the user. For example, a system manager may not pay much attention to an offer of extra memory when he has sufficient free memory to last three months, whereas he may be more receptive to an offer of extra memory when he has only three days' worth of spare memory.

The e-appliance may take different forms. For example, it may be a business operation tool, a server, a database system, an e-mail system or a data storage system. In one embodiment, the hardware of the e-appliance is unmodifiable.

To aid the understanding of the invention, certain embodiments of the invention will now be described, by way of example only, with reference to the accompanying drawing showing a block diagram illustrating an e-appliance and its connection to a service provider.

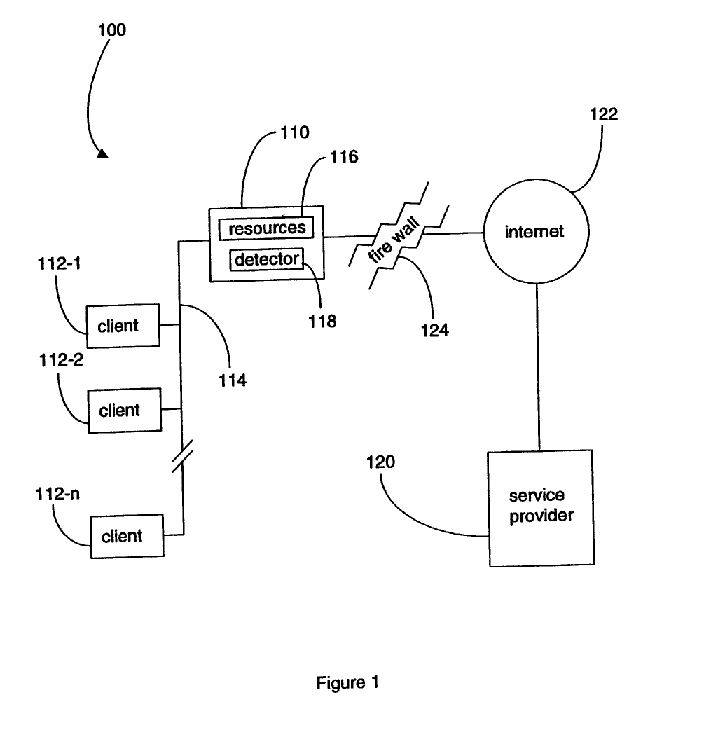

The computer system 100 of FIG. 1 comprises an e-appliance 110 (in this example a server) which services a number of client computers 112-1 to 112-n. The e-appliance 110 is connected to the client computers 112-1 to 112-n by a local area network (LAN) 114. The e-appliance 110 comprises a group of resources 116 which it uses to service the requests from the client computers 112-1 to 112-n. The e-appliance 110 also comprises a detector 118. The detector 118 provides an offer to the manager of the e-appliance 110 (i.e., the system manager responsible for LAN 114) upon the occurrence of a certain condition and, upon acceptance of the offer by the manager, sends a request to a service provider 120. The operation of the detector 118 will be described in detail later. In order to transmit the request to the service provider 120, the e-appliance 110 is connected to the internet 122, through which the request reaches the service provider 120. The e-appliance 110 has a fire wall 124 between itself and the internet to maintain the security of the LAN 114.

In a first set of embodiments, the detector 118 is arranged to respond to a lack of resources within the e-appliance. Upon detecting that the e-appliance 110 will shortly exceed the capabilities of its resources 116, the detector 118 presents to the system manager an offer for the service provider 120 to augment the resources 116 of the e-appliance 110. If the system manager accepts the offer, then detector 118 communicates the acceptance via the fire wall 124 and internet 122 to the service provider 120. In response, the service provider makes available extra resources which the e-appliance 110 may then utilise via the internet 122. Therefore, the service provider becomes a virtual extension of the e-appliance 110. Of course, the service provider may allocate resources to other e-appliances connected to it via the internet 122. Therefore, service provider 120 forms a virtual extension of a number of distinct computer systems. The service provider invoices the system manager of LAN 114 for the extra resources allocated to e-appliance 110.

The detector 118 times the offer to the system manager to enhance the attractiveness of the offer. For example, the detector 118 may determine that a lack of resources event will occur at a certain point in time in the future. The detector 118 may wait until a certain period of time before the anticipated lack of resources event before making the offer to the system manager. This ensures that the issue of the lack of resources is at the forefront of the system manager's mind. Of course, it is possible for the detector (either alternatively or additionally) to respond immediately upon forecasting a lack of resources event, or subsequent to the occurrence of the lack of resources. For example, the offer may be made or repeated after the e-appliance 110 has attempted to exceed the capabilities of its resources 116 or where all or part of the resources 116 within the e-appliance 110 have failed causing a shortfall in the resources available. The nature of the resources in question will now be discussed by reference to a non-limiting series of examples (to which extensions and alternatives will be readily apparent to the skilled person).

In one embodiment, the detector 118 may forecast that the e-appliance 110 will shortly run out of memory space. The detector offers additional memory space (at service provider 120) to the system manager. If the system manager accepts, then extra memory is made available at the service provider 120.

In another embodiment, the detector 118 may forecast that the e-appliance 110 will shortly lack the ability to process, at a sufficient speed, jobs that it receives from the client computers 112-1 to 112-n or that arise in the e-appliance itself. The detector may offer the system manager processing resources at the service provider 120. If the system manager accepts, then additional processing resources are made available at the service provider and thereafter jobs from the client computers 112-1 to 112-n or jobs arising in the e-appliance itself may be transferred to service provider 120 for execution there to ease the burden on the processing resources of the e-appliance 110.

In a further embodiment, the detector 118 detects that the amount of data stored in e-appliance 110 that has not been backed-up has exceeded a threshold value. The detector 118 then asks the system manager if he wishes this vulnerable data to be backed-up on the service provider 120. If the system manager accepts this offer, then the vulnerable data is backed-up on the service provider 120.

In yet another embodiment, the e-appliance 110 has e-mail resources which are capable of managing a maximum number of e-mail accounts. When a client computer is introduced to the LAN 114, one of the e-mail accounts is allocated to that client computer. The situation will arise where the maximum number of e-mail accounts that can be managed by the resources 116 has been reached. If a further client computer is then added to the system, clearly there will be a lack of resources. Here, the detector monitors the number of e-mail accounts remaining at e-appliance 110, and when there are few unused accounts left, the detector asks the system manager if he desires the number of e-mail accounts available at e-appliance 110 to augmented by the making available of further e-mail accounts at service provider 120. If the system manager accepts, then further e-mail accounts are made available at service provider 120, and the number of e-mail accounts available within LAN 114 is correspondingly increased.

Hence, it will be seen that the e-appliance 110 can be augmented with the assistance of the service provider 120. This facilitates the manufacture of the e-appliance 110 as an off-the-shelf unit. Subsequently, if its abilities need to be tailored in some way, then this can be achieved with the aid of the service provider.

The condition or event to which the detector 118 responds may be modifiable. For example, it may be selectable from a menu provided by the e-appliance 110 to the system manager or it may be set remotely and dynamically by the system provider 120 or it may be set during the manufacture of the e-appliance.

In another set of embodiments, the detector 118 is arranged to respond to a condition other than a lack of resources. In the second group of embodiments, the detector responds to a characteristic of the manner in which the tool embodied by the e-appliance 110, is being used. For example, the detector 118 may be responsive to a characteristic which is an undesirable event in the pursuits of the user in which the e-appliance is being exploited. This concept will now be explained further with reference to several non-limiting examples.

In one embodiment, the e-appliance runs a financial management software package. The detector 118 is arranged to monitor the financial health of a business whose financial records are held in the financial management software, and is arranged to offer financial services to the system manager upon determining that the business utilising the software is in poor financial health. The financial services offered may be, for example, a loan. If the system manager accepts this offer, then it is communicated by the detector 118 to the service provider 120, which then arranges the financial services offered.

In another embodiment, the e-appliance runs financial software used to record the telecommunications charges incurred by the business owning the e-appliance. The detector 118 is arranged to monitor the telecommunications charges and, if they exceed a given level, offer cheaper telecommunications services to the system manager. If the system manager accepts, then the acceptance is communicated to the service provider 120, which, in turn, arranges for the cheaper telecommunications services to be supplied.

In a further embodiment, the e-appliance runs software which implements a personnel system for the human resources department of a business. The detector 118 is arranged to review the human resources records and if it detects a lack of human resources (e.g. in terms of deficiencies in the number of employees or the skills of the employees) then it offers appropriate personnel services to the system manager. If the system manager accepts this offer, then the service provider 120 arranges for the provision of the desired personnel services.

What we claim is:

1. An e-appliance, comprising:
resources for performing data processing functions required of the e-appliance; and
a detector for monitoring a condition of the e-appliance and arranged to trigger an offer of an external service to a user of the e-appliance when detecting a predetermined condition indicative of user need.

2. An e-appliance according to claim 1, wherein:
the user need is a lack of resources associated with the e-appliance.

3. An e-appliance according to claim 2, wherein:
the lack of resources is caused by at least one of a failure of resources associated with the e-appliance and use of the e-appliance exceeding its resources.

4. An e-appliance according to claim 2, wherein:
the external service offered is an augmentation of the lacked resources.

5. An e-appliance according to claim 2, wherein:
said lacked resources are at least one of an ability to store data, an ability to process data, an ability to handle e-mail and an ability to back-up data.

6. An e-appliance according to claim 2, wherein:
said lacked resources are hardware resources.

7. An e-appliance, according to claim 1, wherein:
the user need is a solution to an undesirable situation in the pursuits of the user.

8. An e-appliance according to claim 7, wherein:
the undesirable situation is the occurrence of at least one of a non-optimal financial situation, high telecommunications charges, and a lack of human resources.

9. An e-appliance according to claim 1, wherein:
the predetermined condition is modifiable.

10. An e-appliance according to claim 1, wherein:
the detector is arranged to offer the service a period prior to the predetermined condition occurring.

11. An e-appliance according to claim 10, wherein:
the period is determined so as to enhance the attractiveness of the offer to the user.

12. An e-appliance according to claim 1, wherein:
there is a group of predetermined conditions, each of which may trigger an offer for a respective service.

13. An e-appliance according to claim 1, wherein:
the detector is arranged to note that the offer has been accepted by the user and to signal the acceptance to the service provider.

14. An e-appliance according to claim 1, wherein:
the hardware of the e-appliance is unmodifiable.

15. An e-appliance according to claim 1, which is one of:
a business operation tool, a server, a database system, an e-mail system and a data storage system.

16. A method of augmenting the capabilities of an e-appliance, the method comprising:
arranging that the e-appliance monitors its own condition and triggers the offer of an external service to a user of the e-appliance when detecting a predetermined condition indicative of user need.

17. A method according to claim 16, wherein:
the user need is a lack of resources associated with the e-appliance.

18. A method according to claim 17, wherein:
the lack of resources is caused by at least one of a failure of resources associated with the e-appliance and use of the e-appliance exceeding its resources.

19. A method according to claim 17, wherein:
the external service offered is an augmentation of the lacked resources.

20. A method according to claim 17, wherein:
said lacked resources are at least one of an ability to store data, an ability to process data, an ability to handle e-mail and an ability to back-up data.

21. A method according to any one of claims 17 to 20, wherein:
said lacked resources are hardware resources.

22. A method according to claim 16, wherein:
the user need is a solution to an undesirable situation in the pursuits of the user.

23. A method according to claim 22, wherein:
the undesirable situation is the occurrence of at least one of a non-optimal financial situation, high telecommunications charges, and a lack of human resources.

24. A method according to claim 16, wherein:
the predetermined condition is modifiable.

25. A method according to claim 16, wherein:
the step of offering the external service comprises:
timing the offer to be made a certain period before the predetermined condition occurs.

26. A method according to claim 25, wherein:
the step of offering the external service comprises:
determining said period so as to enhance attractiveness of the offer to the user.

27. A method according to claim 16, wherein:
there is a group of predetermined conditions, each of which may trigger an offer for a respective service.

28. A method according to claim 16, further comprising:
noting that the offer has been accepted by the user; and
signalling the acceptance to the service provider.
